(19) United States
(12) Patent Application Publication
(10) Pub. No.: US 2007/0020607 A1
(43) Pub. Date: Jan. 25, 2007

(54) Methods for the storage and deglycerolization of red blood cells

(75) Inventors: Harold T. Meryman, Ashton, MD (US); Claes F. Hogman, Uppsala (SE)

Correspondence Address: PILLSBURY WINTHROP SHAW PITTMAN LLP, P.O BOX 10500, McLean, VA, 22102, US

(73) Assignee: Mission Medical, Inc., Fremont, CA (US)

(21) Appl. No.: 11/187,521

(22) Filed: Jul. 22, 2005

(51) Int. Cl. A01N 1/02

(52) U.S. Cl. 435/2

(57) ABSTRACT

The present invention relates to improved methods for the anticoagulation of whole blood and the subsequent refrigerated storage of red blood cells and to improved methods for removing glycerol from frozen-thawed red blood cells.

### FIELD OF THE INVENTION

The present invention relates to improved methods for the refrigerated storage of red blood cells. The present invention also relates to improved methods for removing glycerol from frozen-thawed red blood cells.

### BACKGROUND OF THE INVENTION

All publications herein are incorporated by reference to the same extent as if each individual publication or patent application was specifically and individually indicated to be incorporated by reference.

The following description includes information that may be useful in understanding the present invention. It is not an admission that any of the information provided herein is prior art or relevant to the presently claimed inventions, or that any publication specifically or implicitly referenced is prior art.

Blood collected from a donor (hereinafter referred to as “whole blood”) includes red blood cells, white cells, plasma and platelets. Because the plasma and the red blood cells may be used for different therapies, separation of the red blood cells from the plasma is often desirable. In addition, a number of disease states require the administration of red blood cells in a purified or semipurified form and thus their separation from the other constituents of whole blood, such as plasma or white blood cells avoids the transfer of these other constituents to the recipient when they would be unsuitable.

To minimize the clumping (i.e. coagulation) of whole blood that would otherwise rapidly occur following collection, freshly drawn whole blood is combined with an anticoagulant. Because anticoagulant solutions typically contain both glucose and various electrolytes, they are prepared at low pH to prevent caramelization of the glucose component during heat sterilization of the solutions. Furthermore, platelet clotting can present problems during separation of blood components if the pH of the anticoagulant solution is not acidic.

Four anticoagulant solutions are commonly used: (1) an acid citrate dextrose (ACD) solution containing a citric acid/sodium citrate buffer as an anticoagulant and dextrose (d-glucose) as an energy source; (2) a citrate salt, a phosphate salt, dextrose (CPD) solution, which is essentially ACD plus monosodium phosphate; (3) a CPD solution with twice the quantity of glucose (CP2D); or (4) a CPD solution that includes adenine (CPDA-1). All of these anticoagulant solutions are kept at a pH of approximately 5.7.

Two general methods currently exist for the refrigerated storage of red blood cells: (1) storage in the presence of plasma and the original anticoagulant solution; and (2) storage that occurs after the red blood cells have been separated from the plasma and anticoagulant solution, and then resuspended in an additive solution that is specifically designed to prolong red blood cell storage. In the case of storage under method (1), CPDA-1 is typically chosen as the anticoagulant. Red blood cells stored in this fashion typically have a five-week shelf life. In the case of storage under method (2), the separation of the red blood cells from the plasma, which generally occurs by centrifugation, does not completely remove the anticoagulant solution. When an additive solution containing a purine base such as adenine is going to be mixed with separated red blood cells, ACD, CPD or CP2D is the typical anticoagulant used.

All additive solutions contain at the very least an energy source and a purine base. The energy source is typically a sugar such as glucose and the purine base is typically adenine. Adenine has been shown to extend the refrigerated storage of red blood cells. Commercially available additive solutions (AS) may also contain sodium chloride and mannitol (e.g. AS-1, AS-5 and SAGM) or sodium chloride, trisodium citrate and monosodium phosphate (e.g. AS-3).

All additive solutions are currently prepared at a pH of no higher than about pH 5.7 because autoclaving (thermal sterilization) of the suspension of the red blood cells causes caramelization (i.e. degradation) of the glucose component when the glucose is in the presence of electrolytes (such as citrate and/or phosphate salts) at a pH greater than about 6.2. The normal pH of blood is approximately 7.2 at 22° C. The low pH (i.e. <about 5.7) required for the additive solutions containing glucose and electrolytes significantly impairs the ability of the red blood cells to effectively maintain metabolic activity.

In the absence of an energy source such as glucose and electrolytes such as phosphate salts, the levels of adenosine triphosphate (ATP) and 2,3-diphosphoglycerate (2,3-DPG) within the red blood cells progressively decrease, resulting ultimately in impairment of function and reduced viability of the red blood cells. The concentration of ATP may decline to between 30% and 40% of its initial levels after six weeks of storage. The level of 2,3-DPG falls rapidly after about three or four days of storage and approaches zero by about ten days. Generally, 2,3-DPG is associated with the ability of hemoglobin present in the red blood cells to deliver oxygen to the tissues, while the level of ATP is loosely correlated with the viability of the red blood cells.

To be acceptable for transfusion, at least 75% of the red blood cells that are transfused must be viable, i.e. circulating in the recipient 24 hours following the transfusion. The cellular concentration of ATP is one of the indicators monitored for the suitability of stored red blood cells for transfusion.

Storage of red blood cells at temperatures slightly above the freezing point results in acidification of the suspension due to the cells' metabolic activity and the production of lactic acid. Typically, the storage conditions become progressively impaired during storage. Both the quality of the stored red blood cells and the length of time that they can remain in refrigerated storage can be improved if the red blood cells are suspended in an alkaline pH solution (i.e. >pH 7.0) which is also hypotonic and chloride-depleted. Alkalinity is important because at a pH below about 6.8, red blood cell metabolism is impaired during storage at about 4° C. Hypotonicity can reduce hemolysis of the red blood cells during storage. The reduction or even elimination of chloride ions has been demonstrated to extend storage by raising intracellular pH through the chloride shift mechanism and to extend the maintenance of 2,3-DPG. Of these three desired attributes of the storage solution, alkalinity is the most important. Hypotonicity and chloride depletion provide little benefit in the absence of an elevated extracellular pH.

The inability to autoclave solutions containing both glucose and electrolytes has created obstacles to the goal of providing a high pH medium for red blood cell storage. Although it is possible to separately sterilize a glucose solution and a high pH electrolyte solution before combining them, this procedure increases cost during commercial production due to FDA regulations requiring that the systems for handling and transferring such solutions must remain closed to the environment after sterilization.

Högman, in Vox. Sang. 65 (1993) 271-8, has reported the use of an additive system (Erythrosol®) wherein the glucose resides in a container separate from the high pH electrolytes and the two are then combined upon introduction to red blood cells. This procedure does result in a sterile high pH medium containing glucose for the red blood cells, but it increases the number of containers by one, resulting in a more expensive storage and delivery system.

Accordingly, the challenge exists to separate the red blood cell component of whole blood at a sufficiently low pH so as to protect the platelets from clumping and then to, within the framework of the FDA's requirements for sterilization, increase the pH of the red blood cell fraction to a level that maximizes storage duration and quality of the cells. The present invention accomplishes these objectives.

To extend the storage of red blood cells beyond that possible at refrigerator temperatures, red blood cells can be frozen in the presence of a high concentration of glycerol, which reduces the amount of ice that forms and therefore protects the cells from injury. Prior to use of these red blood cells for subsequent refrigerated storage or transfusion, the glycerol must be removed. In the past, the storage time of red blood cells after deglycerolization was limited to 24 hours because the processes for adding and removing the glycerol were not completely closed to the environment. New technologies have remedied this shortcoming such that post-thaw refrigerated storage of deglycerolized red blood cells is limited only by degeneration of the quality of the cells below acceptable limits. Moore et al. in Vox. Sang. 53, 19-22 (1987) reported deglycerolizing frozen red blood cells using a phosphate-buffered sodium chloride wash solution followed by resuspension in a solution containing adenine, ascorbate-2-phosphate, trisodium phosphate, dextrose and mannitol at a pH of 11.0 and an osmolality of 446 mOsm. Both ATP and 2,3-DPG were reported to have been adequately maintained for 21 days. However, the benefits of this solution were found to be due to contamination of the ascorbate by oxalate. Ascorbate-2-phosphate has not been licensed for use in a solution for transfusion.

Current limitations in the use of frozen red cells are related to the complexity of the introduction and removal of glycerol. Both the addition and the removal of glycerol must be conducted with great care to avoid hemolysis. The critical need for extended storage of transfusible red blood cells is driving the development of improved procedures for the routine deglycerolization and subsequent storage of frozen-thawed red blood cells. Especially beneficial would be the development of solutions that are suitable both for washing glycerol from the frozen-thawed red blood cells and for their subsequent storage. The present invention provides these solutions and a process for deglycerolizing red blood cells that leaves them suitable for prolonged refrigerated storage in the liquid state and for transfusion.

### SUMMARY OF THE INVENTION

One aspect of the invention provides a medium for prolonging the viability of red blood cells under refrigerated storage consisting of a mixture of two sterilized solutions in proportions sufficient to support metabolism of the red blood cells, wherein one of the sterilized solutions is at a pH of less than 7.0 and comprises an anticoagulant and at least glucose as a sugar; the other of the sterilized solutions is at a pH of greater than 7.0 and comprises at least one phosphate salt, and at least one purine base is present in at least one of the two solutions.

Another aspect of the invention provides a process for prolonging the viability of red blood cells under refrigerated storage, comprising the steps of contacting freshly collected whole blood with a first solution at a pH of less than 7.0 and comprising an anticoagulant and at least glucose as a sugar; separating the red blood cells from other components of the whole blood; and introducing to the red blood cells suspended in an amount of the first solution remaining after the separation step, a mixture of the first solution with a second solution in proportions sufficient to support metabolism of the red blood cells, wherein the second solution is at a pH of greater than 7.0 and comprises at least one phosphate salt, at least one purine base is present in the first solution and/or the second solution and the first and the second solutions have been sterilized prior to their mixing together.

Another aspect of the invention provides a process for prolonging the viability of red blood cells under refrigerated storage, comprising the step of introducing to separated red blood cells a mixture of a sterilized first solution with a sterilized second solution in proportions sufficient to support metabolism of the red blood cells, wherein

the first solution is at a pH of less than 7.0 and comprises an anticoagulant and at least glucose as a sugar, the second solution is at a pH of greater than 7.0 and comprises at least one phosphate salt, and at least one purine base is present in the first solution and/or the second solution.

Yet another aspect of the invention provides a process for the deglycerolization of frozen-thawed red blood cells, comprising the steps of contacting the frozen-thawed red blood cells with a sterilized hypertonic first solution at a pH of less than 7.0 comprising at least glucose as a sugar; washing the red blood cells with a solution generated by mixing the hypertonic first solution with a sterilized isotonic, hypotonic or hypertonic second solution at a pH of greater than 7.0 and comprising at least one phosphate salt in proportions sufficient to produce a wash solution of either a fixed osmolality, a series of different osmolalities or a continually changing osmolality to optimize the efficiency of the wash process; and repeating the washing step as necessary to provide a medium for the red blood cells that is suitable either for direct transfusion into a recipient or for supporting metabolism of the red blood cells during extended refrigerated storage, wherein at least one purine base is present in the first solution and/or the second solution.

Another aspect of the invention provides a process for the deglycerolization of frozen-thawed red blood cells, comprising the steps of contacting the frozen-thawed red blood cells with a sterilized hypertonic first solution at a pH of greater than 7.0 comprising at least one phosphate salt; washing the red blood cells with a solution generated by mixing the hypertonic first solution with a sterilized isotonic or hypotonic second solution at a pH of less than 7.0 comprising at least glucose as a sugar in proportions sufficient to produce a wash solution of either a fixed osmolality, a series of different osmolalities or a continually changing osmolality to optimize the efficiency of the wash process; and repeating the washing step as necessary to provide a medium for the red blood cells that is suitable either for direct transfusion into a recipient or for supporting metabolism of the red blood cells during extended refrigerated storage, wherein at least one purine base is present in the first solution and/or the second solution.

### BRIEF DESCRIPTION OF THE DRAWINGS

The accompanying drawings, which are incorporated in and constitute a part of this specification, illustrate exemplary embodiments of the invention. In the schematics of FIGS. 1 and 2: RBC=red blood cells; US=ultrasonic sensor, such as an ultrasonic air sensor; V=valve, such as a solenoid valve; P=pressure sensor; CFC=continuous flow centrifuge, and LF=leukofilter (FIG. 2 only).

FIG. 1. The schematic for deglycerolizing frozen-thawed red blood cells illustrates that solutions 1 and 2 could be combined in any ratio by adjusting the speeds of solution pumps 1 and 2.

FIG. 2. The schematics of FIGS. 2.1, 2.2, and 2.3 are for a blood collection and separation system where whole blood is collected from a donor; anticoagulant is added to the whole blood; a CFC separates the blood into packed RBCs, plasma, and buffy coat or platelets; and RBCs are removed from the CFC and a storage solution is added to them.

FIG. 2.1: In this schematic for the blood collection system solution 1 can be added to solution 2 to form a red cell storage solution prior to initiating blood flow from the donor. Solution 1is the anticoagulant metered into whole blood from the donor. Alternatively, solution 2 is added to solution 1 to form the anticoagulant solution prior to initiating blood flow from the donor. Then solution 2 is the red cell storage solution metered into packed red cells flowing out of the CFC.

FIG. 2.2:

In this schematic for the whole blood collection system solution 1 is the anticoagulant metered into whole blood flowing from the donor using the AC pump.

Solution 1 is metered by solution 1 pump into a solution 2 flow controlled by solution 2 pump. The solution 1 and solution 2 pump flow rates or speeds control the ratio of solution 1 and solution 2 in the mixture. This mixture is the red cell storage solution which is metered into packed red cells flowing out of the CFC.

FIG. 2.3:

In this schematic solution 2 is pumped into the solution 1 bag using the solution 2 pump and the solution 1 pump with V4 open. This occurs before blood flow from the donor begins. The mixture of solution 1 and solution 2 form the anticoagulant.

With blood flowing from the donor this anticoagulant is metered into the blood using solution 1 pump with V3 open.

Solution 2 is the red cell storage solution. It is pumped into the packed red cells flowing out of the CFC using the solution 2 pump with V4 closed.

### DETAILED DESCRIPTION OF THE INVENTION

Unless defined otherwise, all technical and scientific terms used herein have the same meaning as is commonly understood by one of skill in the art.

As used herein, “refrigerated” refers to any temperature between about 0° C. and about 6° C.

As used herein, “acidic pH” or “low pH” refers to any pH less than 7.0. Similarly, “basic pH” or “alkaline pH” or “high pH” refers to any pH greater than 7.0.

As used herein, “dextrose,” “glucose” and “d-glucose” are used interchangeably. The “d” prefix refers to the dextrorotatory form of the molecule as opposed to the “l” or levorotatory form.

As used herein, the nomenclature “monosodium phosphate” is used interchangeably with “monobasic sodium phosphate” and both are equivalent to the formula “NaH₂PO₄.” Similarly, “disodium phosphate” is used interchangeably with “dibasic sodium phosphate” and both are equivalent to “Na₂HPO₄.” “Trisodium phosphate” is used interchangeably with “tribasic sodium phosphate” and both are equivalent to “Na₃PO₄.” “Phosphate salts” or “a phosphate salt”, without additional clarification, is intended to encompass monosodium, disodium and/or trisodium phosphates.

As used herein, the nomenclature “monosodium citrate” is used interchangeably with “monobasic sodium citrate.” Similarly, “disodium citrate” is used interchangeably with “dibasic sodium citrate,” and “trisodium citrate” is used interchangeably with “tribasic sodium citrate.” “Citrate salts” or “a citrate salt”, without additional clarification, is intended to encompass monosodium, disodium and/or trisodium citrate.

As used herein, “frozen-thawed” refers to red blood cells that were previously in a frozen state and have subsequently been allowed to warm to either a partially frozen state or a completely liquid state.

As used herein, “hypertonic” means having an osmolality greater than about 300 milliosmolar which is the approximate osmolality of human plasma.

As used herein, “hypotonic” means having an osmolality lower than about 300 milliosmoles.

As used herein, “isotonic” means having an osmolality equal to about 300 milliosmoles.

As used herein, “effective osmolality” means the osmolality of only those solutes that do not penetrate the cell and therefore influence the volume of the cell. Solutes that do penetrate the cell establish an equilibrium across the membrane and therefore exert no net effect on cell volume.

As used herein, “sterilized” means treated in such a manner as to inactivate all microorganisms. In the context of this invention, sterilization is achieved by heating.

As used herein, “viable” means possessing a functioning metabolism and capable of performing all life functions appropriate to the organism in question.

As used herein, “medium” means the supporting environment. In a preferred embodiment, the suspending solution containing the red blood cells qualifies as a medium.

As used herein, “to support metabolism of red blood cells” means to provide conditions necessary to enable the red blood cells to carry out those functions essential to the maintenance of viability.

As used herein, “freshly collected whole blood” means blood collected directly from a donor.

Collection and Storage of Red Blood Cells

One aspect of the present invention provides for the optimal use of both a low pH anticoagulant solution (solution 1) for minimizing clotting of whole blood following collection and a high pH additive solution (solution 2) for maximizing the viability of red blood cells during extended refrigerated storage. The invention accomplishes this objective by combining the separately stored solutions 1 and 2 in different ratios. This combination step is readily achieved by using an automated apparatus that has the ability to accurately meter solutions 1 and 2 according to a predefined program.

Accordingly, another aspect of the invention is a medium for prolonging the viability of red blood cells under refrigerated storage consisting of a mixture of two sterilized solutions in proportions sufficient to support metabolism of the red blood cells, wherein one of the sterilized solutions (solution 1) is at a pH of less than 7.0 and comprises an anticoagulant, an energy source that is at least glucose as a sugar and optionally at least one purine base; and the other sterilized solution (solution 2) is at a pH of greater than 7.0 and comprises at least one phosphate salt and optionally at least one purine base. The at least one purine base must be present in at least one of the solutions 1 and 2.

An example of an anticoagulant is a combination of citric acid and a citrate salt. Citrate salts may include, but are not limited to, monosodium citrate, disodium citrate and trisodium citrate.

Sugars or sugar alcohols may include, but are not limited to, glucose, sucrose, fructose and mannitol.

Phosphate salts may include, but are not limited to, monosodium phosphate, disodium phosphate and trisodium phosphate.

A purine base may include, but is not limited to, adenine and inosine.

In a preferred embodiment, the anticoagulant is citric acid and trisodium citrate, and the at least one sugar is glucose only.

In another preferred embodiment, the purine base is adenine and the phosphate salts are disodium phosphate and trisodium phosphate.

In another preferred embodiment, the pH of solution 1 is less than about 6.0 and the pH of solution 2 is greater than about 8.0. In another preferred embodiment, the pH of solution 2 is greater than about 8.5.

The concentration of the citrate salt ranges from about 30 mM to about 150 mM. The concentration of the citric acid ranges from about 0 mM to about 50 mM. The concentration of the glucose ranges from about 20 mM to about 400 mM. In a preferred embodiment, the concentration of the citrate salt ranges from about 40 mM to about 100 mM, the concentration of the citric acid ranges from about 10 mM to about 20 mM and the concentration of the glucose ranges from about 200 mM to about 300 mM.

The concentration of the phosphate salt ranges from about 10 mM to about 40 mM. The concentration of the purine base ranges from about 1 mM to about 3 mM. In a preferred embodiment, the concentration of the phosphate salt ranges from about 12 mM to about 20 mM and the concentration of the purine base ranges from about 1.2 mM to about 2 mM.

In another aspect of the invention, at least one of the sterilized solutions 1 or 2 of the medium further comprises mannitol.

In a preferred embodiment, the concentration of the mannitol ranges from about 20 mM to about 50 mM.

In yet another aspect of the invention, at least one of the sterilized solutions 1 or 2 of the medium further comprises gluconate.

In a preferred embodiment, the concentration of the gluconate ranges from about 20 mM to 100 mM.

Solution 1 may be used undiluted as an anticoagulant for the collection of whole blood. Some of the at least glucose as the sugar in solution 1 diffuses into the red blood cells, contributing to the sugar content of the final medium. Because of its low pH, solution 1 can be autoclaved without risk of glucose carmelization. After the separation process is complete, an additive solution that consists of a mixture of solutions 1 and 2 is added to the red blood cells. In a preferred embodiment, solution 2 provides adenine and a phosphate salt or salts at a high pH while solution 1 provides citric acid, a citrate salt and glucose, in addition to whatever remains of the initial anticoagulant accompanying the separated red blood cells. The phosphate salt in solution 2 is stronger in controlling pH than the citrate salt buffer in solution 1, such that even in combination with solution 1, the pH of the resulting medium in which the red blood cells reside can be raised sufficiently to support cellular metabolism during refrigerated storage.

Accordingly, another aspect of the invention provides a process for maintaining the oxygen release capability of the red blood cells and for prolonging their viability under refrigerated storage, comprising the steps of contacting freshly collected whole blood with a first solution at a low pH (solution 1) and comprising a citrate salt, citric acid and at least glucose as a sugar (the at least glucose acts to load the red blood cells up by penetrating the cell membranes); separating the red blood cells from other components of the whole blood; and introducing to the red blood cells suspended in an amount of the first solution remaining after the separation step, a mixture of the first solution with a second solution (solution 2) in proportions sufficient to support metabolism of the red blood cells, wherein the second solution is at a high pH and comprises at least one phosphate salt, and wherein the first and the second solutions have been sterilized prior to their mixing together. At least one purine base is present in solution 1 and/or solution 2.

Yet another aspect of the invention provides a process for maintaining the oxygen release capability of the red blood cells and prolonging their viability under refrigerated storage, comprising the step of introducing to separated red blood cells a mixture of a sterilized first solution with a sterilized second solution in proportions sufficient to support metabolism of the red blood cells, wherein the first solution is at a low pH (solution 1) and comprises an anticoagulant (e.g., a citrate salt and citric acid) and at least glucose as a sugar; and wherein the second solution is at a high pH (solution 2) and comprises at least one phosphate salt. At least one purine base is present in solution 1 and/or solution 2.

In a preferred embodiment, the first solution serves as the anticoagulant. The mixture of the first solution (solution 1) with the second solution (solution 2) is generated by an automated apparatus according to a predetermined program. More specifically, apparatus pumps accurately control metering of the first and second solutions to provide a medium that optimally supports red blood cell metabolism.

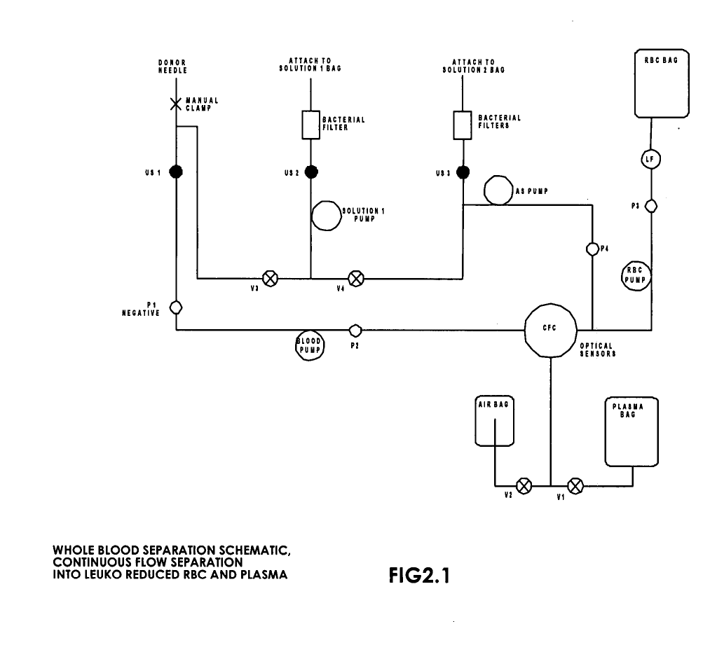

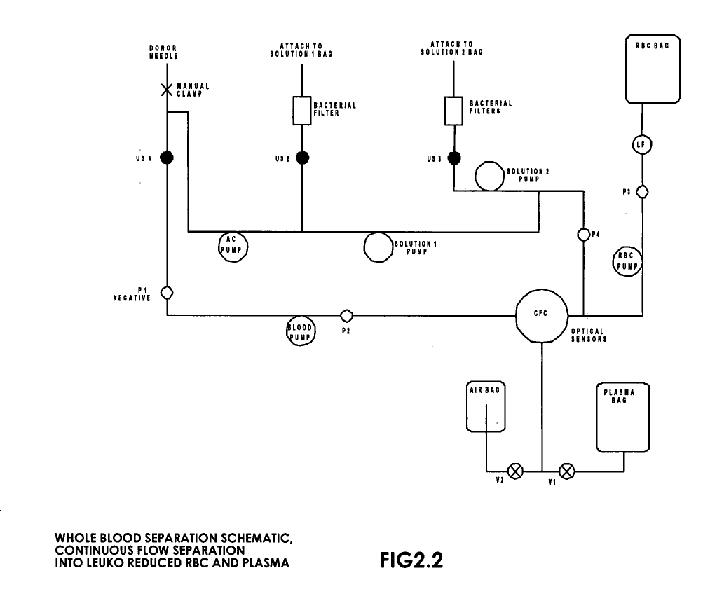

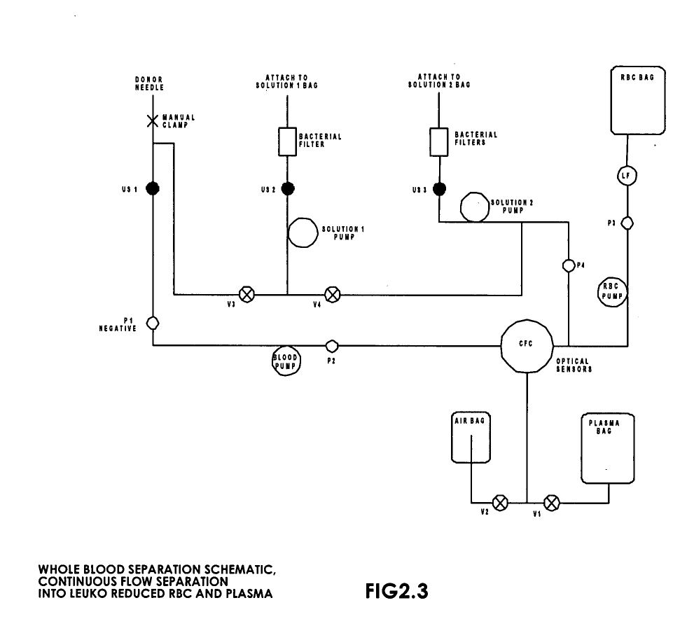

In a preferred embodiment, an automated apparatus has been developed that will facilitate collection and storage of the red blood cells. For example, the Mission Medical M2000 is designed to collect whole blood from a donor while introducing an anticoagulant at the base of the venipuncture needle. The anticoagulated blood is then pumped through a continuous-flow centrifuge that separates the whole blood into red blood cells, plasma and platelets. An additive solution is then added to the red blood cells, which are then pumped through a leukocyte-depletion filter into a collection bag. As illustrated in FIG. 2, both the anticoagulant and the additive solution can be formed by mixing solution 1 and solution 2 in any desired ratio by means of pumps. In FIGS. 2.1 and 2.2, representing preferred embodiments, the solution 1 is the anticoagulant which is mixed with solution 2 to form the desired ratios of solution 1 and 2. This mixture is the red cell storage or additive solution metered into packed red cells flowing out of the CFC.

In FIG. 2.1, the solution 1 is added to solution 2 in the solution 2 bag using the solution 1 pump with V4 open and V3 closed. This red cell storage solution or mixture preparation occurs before blood flow from the donor begins.

In FIG. 2.2 the solution 1 is metered by means of the solution 1 pump into the solution 2 flowing out of the solution 2 pump. This red cell storage solution or mixture is directly metered into packed red cells flowing out of the CFC. A separate AC pump controls the flow of anticoagulant (solution 1) into the flowing whole blood from the donor. This separate pump is needed because anticoagulant flow to donor blood is simultaneous with adding red cell storage solution into packed red cells leaving the CFC for most of this process.

In another preferred embodiment, the chemical compositions of the first and second solutions used in the processes of the invention are identical to the chemical compositions of the low pH and high pH sterilized solutions, respectively, comprising the medium for the storage of red cells. In other words, the anticoagulant and the at least glucose of the first solution (solution 1) are citric acid and trisodium citrate, and glucose only, respectively. Similarly, the at least one phosphate salt of the second solution (solution 2) is disodium phosphate, and adenine is the at least one purine base. To supplement the osmolality of the storage medium and to sustain a satisfactory intracellular pH, solution 2 typically contains citrate and/or gluconate.

Solutions 1 and 2 may be separately stored in any suitable container prior to their controlled mixing. Containers include bags and pouches that are resistant to acidic and basic pH levels. The upper range of the pH of solution 2 is typically largely dependent on the tolerance of the container material to alkaline conditions.

Deglycerolization of Frozen-Thawed Red Blood Cells

Glycerolized red blood cells have an osmolality of approximately 4.5 osm or 15× isotonic. When the intracellular and extracellular concentrations of glycerol are equal, there is no effect on red blood cell volume. However, if the extracellular concentration is altered, there will be an osmotic effect on cell volume until the intracellular and extracellular concentrations of glycerol again come to equilibrium. The challenge of deglycerolizing red blood cells is to resuspend the cells in a glycerol-poor solution without allowing the osmotic gradient from the glycerol-rich cell interior to the glycerol-poor exterior to swell the cells beyond their hemolytic volume.

Red blood cells can swell to 2× their normal volume and shrink to ¼× their normal volume without injury. In light of these limitations, when a glycerol-free solution is added to glycerolized red blood cells, it must have an osmolality of no less than half that of the intracellular medium so that cells coming into contact with the undiluted glycerol-free solution will not swell beyond twice normal volume. The volume of the hypertonic, glycerol-free diluent that is added to the glycerolized red blood cells should be such that after the glycerolized red blood cells have come to equilibrium, the final osmolality of the extracellular non-penetrating solutes is approximately 4× isotonic. Subjection to this medium shrinks the cells to a safe minimum volume, which aids both in expelling intracellular glycerol and in lessening the risk of hemolysis of the cells during subsequent hypotonic washings.

According to current practice, glycerolized red blood cells are diluted with a 12% hypertonic sodium chloride solution or, alternatively, with a 50% glucose solution. Glucose rapidly enters the cell up to 2%, following which the remainder enters slowly such that 50% glucose is initially osmotically effective. The subsequent wash solution currently consists of an isotonic sodium chloride solution at a pH of approximately 5.7 and containing 0.2% glucose.

After the washing step, a storage additive is added to the red blood cells as an extra step. The majority of currently used storage solutions contain glucose and adenine, in addition to electrolytes such as monosodium phosphate, citric acid and trisodium citrate. They are typically prepared at a pH of no higher than 6.0 because of the problems associated with the caramelization of glucose in the presence of electrolytes during heat sterilization at a pH much above 6.2.

It would be advantageous if the wash solution used for deglycerolizing the red blood cells were also sufficient for sustaining cell metabolism. As such, the red blood cells would already be suspended in the storage solution rather than having to add it as an extra step in the process. The present invention disposes of the need for the extra step by accomplishing this objective.

Accordingly, an aspect of the invention is a process for the deglycerolization of frozen-thawed red blood cells, comprising the steps of contacting the frozen-thawed red blood cells with a sterilized hypertonic first solution at a pH of less than 7.0 comprising at least glucose as a sugar; washing the red blood cells with a solution generated by mixing the hypertonic solution with a sterilized isotonic, hypotonic or hypertonic second solution at a pH of greater than 7.0 and comprising at least one phosphate salt in proportions sufficient to produce a wash solution of either a fixed osmolality, a series of different osmolalities or a continually changing osmolality to optimize the efficiency of the wash process; and repeating the washing step as necessary to provide a medium for the red blood cells that is suitable either for direct transfusion into a recipient or for supporting metabolism of the red blood cells during extended refrigerated storage. At least one purine base is present in the first solution and/or the second solution.

In a preferred embodiment, the at least glucose as a sugar is glucose only, the at least one phosphate salt is disodium phosphate and the at least one purine base is adenine.

In another preferred embodiment, the pH of the second solution is at least 8.0.

In yet another preferred embodiment, the pH of the second solution is at least 8.5.

In a preferred embodiment, the concentration of glucose in the first solution ranges from about 30 g/dL to about 70 g/dL.

In another aspect of the invention, the second solution may further contain a component selected from disodium phosphate, trisodium phosphate, trisodium citrate, sodium chloride, mannitol and mixtures thereof.

In a preferred embodiment of a deglycerolization process of the invention, the mixture of the first solution with the second solution is prepared by an automated apparatus according to a predetermined program. More specifically, apparatus pumps accurately control metering of the first and the second solutions in any ratio to produce a wash solution of either a fixed osmolality, a series of different osmolalities or a continually changing osmolality in order to optimize the efficiency of the wash process.

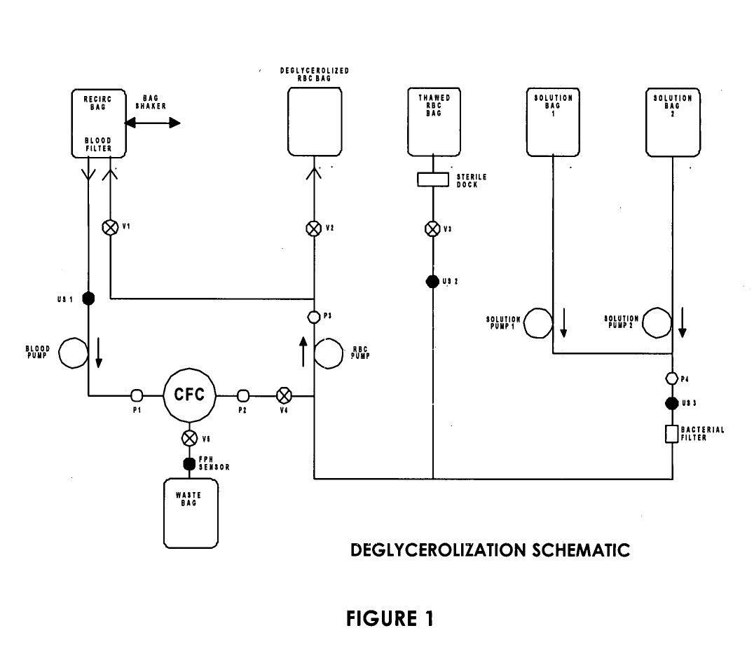

In a preferred embodiment of the invention, an apparatus, exemplified by the Mission Medical M1000, adds a hypertonic solution to the red blood cell suspension to shrink the cells, expelling much of the intracellular glycerol. The M1000 then progressively dilutes the red blood cell suspension as it is being recirculated through a separator. The separator functions by removing excess solution, with the process continuing until glycerol has been effectively removed from the red blood cells. FIG. 1 gives a schematic of this recirculation process. Thawed RBCs are pumped into a recirculation bag using the RBC pump (V2 closed and V1 open) while solution 1 or solution 2 or a mixture of solutions 1 and 2 are metered into these RBCs. Then the blood pump pumps these red cells out of the recirculation bag into a CFC where RBCs are separated from liquid. The waste liquid, carrying glycerol and free hemoglobin, enters the waste bag. The RBC pump pumps RBCs back to the recirculation bag (V2 and V3 closed, V1 open). Solution 1, or solution 2, or a mixture of the two are metered into the RBCs exiting the CFC. This recirculation provides for serial dilution of RBCs followed by concentration and waste liquid removal, a continuous red cell washing process.

Yet another aspect of the invention provides a process for the deglycerolization of frozen-thawed red blood cells, comprising the steps of contacting the frozen-thawed red blood cells with a sterilized hypertonic first solution comprising at least one phosphate salt or at least sodium chloride at a pH of greater than 7.0; and then washing the red blood cells with a solution generated by mixing the hypertonic first solution with a sterilized isotonic or hypotonic second solution comprising at least glucose as a sugar at a pH of less than 7.0 in proportions sufficient to produce a wash solution of either a fixed osmolality, a series of different osmolalities or a continually changing osmolality to optimize the efficiency of the wash process; and repeating the washing step as necessary to provide a medium for the red blood cells that is suitable either for direct transfusion into a recipient or for supporting metabolism of the red blood cells during extended refrigerated storage. At least one purine base is present in the first solution and/or second solution. FIG. 1 is a schematic drawing showing the implementation of this process using solution pumps to control the ratio of the two solutions mixed together.

In a preferred embodiment, the concentration of the glucose in the isotonic or hypotonic second solution is about 0.5 g/dL to about 2.5 g/dL.

In all of the deglycerolization processes of the invention, the concentration of the individual constituents of the two solutions used can be varied over a wide range to achieve the desired results. For example, the concentrations of the glucose and electrolyte solutions can be altered, provided that the osmolalities of the hypertonic dilution and the wash solution are high enough to minimize hemolysis during the early stages of the washing. The osmolality of the wash solution may range from hypotonic to moderately hypertonic. The osmolality of the wash solution can also be increased by the addition of mannitol.

Given the flexibility of an automated delivery system, several variations of the deglycerolization processes, as exemplified above, are achieveable. In general, the automated system is capable of handling combinations of a hypertonic first solution that contains at least glucose at a low pH or electrolytes at a high pH, with a second solution that may be isotonic, hypotonic or moderately hypertonic in the low pH glucose case or isotonic or hypotonic in the high pH electrolytes case.

### EXAMPLES

### Example 1

### Blood Collection

Solution 1 (CP2D) (20 mL) (pH 5.7):

15.6 mM citric acid

89.6 mM trisodium citrate

257.9 mM glucose

16.1 mM monosodium phosphate

Solution 2 (180 mL) (pH 10.5):

4 mM disodium phosphate

12 mM trisodium phosphate

1.5 mM adenine

30 mM mannitol

30 mM sodium gluconate

Solutions 1 and 2 were stored separately in two bags. Solution 1 was used as anticoagulant in whole blood in a ratio of 0.11 mL to 1.0 mL, respectively. After separation of the red blood cells from the whole blood, an additive solution (200 mL), prepared by mixing solution 1 (20 mL) with solution 2 (180 mL), was added. The resulting medium created by this mixing had a pH of 9.5 and the higher concentration of glucose in CP2D results in more carry-over after separation with a resulting improvement in storage quality.

### Example 2

### Deglycerolization

Solution 1:

2.5M glucose (50 g/dL)

Solution 2 (pH 7.5; effective osmolality of 126 mOsm):

12 mM disodium sodium phosphate

2.9 mM monosodium phosphate

30.6 mM trisodium citrate

0.02 mM adenine

After the initial hypertonic dilution of the frozen-thawed red blood cells with 2.5M glucose, the cells will be washed with solution 2. To provide adequate osmolality during the initial part of the wash, solution 1 may be metered together with solution 2 at a ratio determined experimentally to minimize hemolysis. The amount of glucose introduced into solution 2 will also be adjusted to provide adequate glucose at the end of the wash to support metabolism during the subsequent refrigerated storage of the red blood cells. The osmolality of solution 2 may be adjusted by altering the concentration of the electrolyte components and/or by the addition of sodium chloride. At the completion of this wash process, the red blood cells will have been suspended in an environment which is high pH, chloride-depleted and of the desired osmolality.

Those skilled in the art will appreciate that various modifications can be made in the present invention without departing from the spirit or scope of the invention. Thus, it is intended that the present invention cover the modifications and variations of this invention provided they come within the scope of the appended claims and their equivalents.

What is claimed is:

1. A medium for prolonging the viability and normal function of red blood cells under refrigerated storage consisting of a mixture of two sterilized solutions in proportions sufficient to support metabolism of the red blood cells, wherein:
one of the sterilized solutions is at a pH of less than 7.0 and comprises an anticoagulant and at least glucose as a sugar;
the other of the sterilized solutions is at a pH of greater than 7.0 and comprises at least one phosphate salt; and
at least one purine base is present in at least one of the two solutions.

2. The medium according to claim 1, wherein the at least glucose as a sugar is glucose only.

3. The medium according to claim 1, wherein the at least one purine base is adenine.

4. The medium according to claim 1, wherein the at least one phosphate salt is selected from monosodium phosphate, disodium phosphate, trisodium phosphate and mixtures thereof.

5. The medium according to claim 1, wherein at least one salt selected from citrate and gluconate is present in at least one of the two solutions.

6. The medium according to claim 5, wherein the at least one salt supports the elevation of intracellular pH through the chloride shift mechanism.

7. The medium according to claim 1, wherein the pH of the one of the sterilized solutions is less than about 6.0.

8. The medium according to claim 1, wherein the pH of the other of the sterilized solutions is greater than about 8.0.

9. The medium according to claim 1, wherein the anticoagulant is a citrate salt and citric acid.

10. The medium according to claim 9, wherein the citrate salt is trisodium citrate.

11. The medium according to claim 9, wherein the citrate salt is present in a concentration of about 30 mM to about 150 mM, the citric acid is present in a concentration of about 0 mM to about 50 mM and the at least glucose as a sugar is present in a concentration of about 20 mM to about 400 mM.

12. The medium according to claim 11, wherein the citrate salt is present in a concentration of about 40 mM to about 100 mM, the citric acid is present in a concentration of about 10 mM to about 20 mM and the at least glucose as a sugar is present in a concentration of about 200 mM to about 300 mM.

13. The medium according to claim 1, wherein the concentration of the at least one phosphate salt is about 10 mM to about 40 mM and the concentration of the at least one purine base is about 1 mM to about 3 mM.

14. The medium according to claim 13, wherein the concentration of the at least one phosphate salt is about 12 mM to about 20 mM and the concentration of the at least one purine base is about 1.2 mM to about 2 mM.

15. The medium according to claim 1, wherein at least one of the two solutions further comprises mannitol.

16. The medium according to claim 15, wherein the mannitol is present in a concentration of about 20 mM to about 50 mM

17. A process for prolonging the viability of red blood cells under refrigerated storage, comprising the steps of:
contacting freshly collected whole blood with a first solution at a pH of less than 7.0 and comprising an anticoagulant and at least glucose as a sugar;
separating the red blood cells from other components of the whole blood; and
introducing to the red blood cells suspended in an amount of the first solution remaining after the separation step, a mixture of the first solution with a second solution in proportions sufficient to support metabolism of the red blood cells,
wherein the second solution is at a pH of greater than 7.0 and comprises at least one phosphate salt, at least one purine base is present in the first solution and/or the second solution and the first and the second solutions have been sterilized prior to their mixing together.

18. The process according to claim 17, wherein the at least glucose as a sugar is glucose only.

19. The process according to claim 17, wherein the at least one purine base is adenine.

20. The process according to claim 17, wherein the at least one phosphate salt is selected from the group consisting of monosodium phosphate, disodium phosphate, trisodium phosphate and mixtures thereof.

21. The process according to claim 17, wherein the pH of the first solution is less than about 6.0.

22. The process according to claim 17, wherein the pH of the second solution is greater than about 8.0.

23. The process according to claim 17, wherein the anticoagulant is a citrate salt and citric acid.

24. The process according to claim 23, wherein the citrate salt is trisodium citrate.

25. The process according to claim 17, wherein the mixture of the first solution with a second solution is generated by an automated apparatus according to a predetermined program.

26. A process for prolonging the viability of red blood cells under refrigerated storage, comprising the step of:
introducing to separated red blood cells a mixture of a sterilized first solution with a sterilized second solution in proportions sufficient to support metabolism of the red blood cells, wherein the first solution is at a pH of less than 7.0 and comprises an anticoagulant and at least glucose as a sugar, the second solution is at a pH of greater than 7.0 and comprises at least one phosphate salt, and at least one purine base is present in the first solution and/or the second solution.

27. The process according to claim 26, wherein the at least glucose as a sugar is glucose only.

28. The process according to claim 26, wherein the at least one purine base is adenine.

29. The process according to claim 26, wherein the at least one phosphate salt is selected from the group consisting of monosodium phosphate, disodium phosphate, trisodium phosphate and mixtures thereof.

30. The process according to claim 26, wherein the pH of the first solution is less than about 6.0.

31. The process according to claim 26, wherein the pH of the second solution is greater than about 8.0.

32. The process according to claim 26, wherein the anticoagulant is a citrate salt and citric acid.

33. The process according to claim 32, wherein the citrate salt is trisodium citrate.

34. The process according to claim 26, wherein the mixture of a sterilized first solution with a second sterilized solution is generated by an automated apparatus according to a predetermined program.

35. A process for the deglycerolization of frozen-thawed red blood cells, comprising the steps of:
contacting the frozen-thawed red blood cells with a sterilized hypertonic first solution at a pH of less than 7.0 comprising at least glucose as a sugar;
washing the red blood cells with a solution generated by mixing the hypertonic first solution with a sterilized isotonic, hypotonic or hypertonic second solution at a pH of greater than 7.0 and comprising at least one phosphate salt in proportions sufficient to produce a wash solution of either a fixed osmolality, a series of different osmolalities or a continually changing osmolality to optimize the efficiency of the wash process; and
repeating the washing step as necessary to provide a medium for the red blood cells that is suitable either for direct transfusion of the red blood cells into a recipient or for supporting metabolism of the red blood cells during extended refrigerated storage,
wherein at least one purine base is present in the first solution and/or the second solution.

36. The process according to claim 35, wherein the at least glucose as a sugar is glucose only.

37. The process according to claim 35, wherein the at least one phosphate salt is disodium phosphate and the at least one purine base is adenine.

38. The process according to claim 35, wherein the pH of the isotonic, hypotonic or hypertonic second solution is at least about 8.0.

39. The process according to claim 38, wherein the pH of the isotonic, hypotonic or hypertonic second solution is at least about 8.5.

40. The process according to claim 36, wherein the concentration of the glucose in the hypertonic first solution is about 30 g/dL to about 60 g/dL.

41. The process according to claim 35, wherein the isotonic, hypnotic or hypertonic second solution further comprises a component selected from the group consisting of monosodium phosphate, disodium phosphate, trisodium citrate, sodium chloride, mannitol and mixtures thereof.

42. The process according to claim 35, wherein the mixture of the sterilized hypertonic first solution with the sterilized isotonic, hypnotonic or hypertonic second solution is generated by an automated apparatus according to a predetermined program.

43. A process for the deglycerolization of frozen-thawed red blood cells, comprising the steps of:
contacting the frozen-thawed red blood cells with a sterilized hypertonic first solution at a pH of greater than 7.0 comprising sodium chloride and/or at least one phosphate salt;
washing the red blood cells with a solution generated by mixing the hypertonic first solution with a sterilized isotonic or hypotonic second solution at a pH of less than 7.0 comprising at least glucose as a sugar in proportions sufficient to produce a wash solution of either a fixed osmolality, a series of different osmolalities or a continually changing osmolality to optimize the efficiency of the wash process; and
repeating the washing step as necessary to provide a medium for the red blood cells that is suitable either for direct transfusion of the red blood cells into a recipient or for supporting metabolism of the red blood cells during extended refrigerated storage,
wherein at least one purine base is present in the first solution and/or the second solution.

44. The process according to claim 43, wherein the at least glucose as a sugar is glucose only, the at least one phosphate salt is disodium phosphate and the at least one purine base is adenine.

45. The process according to claim 43, wherein the mixture of the sterilized hypertonic first solution with the sterilized isotonic or hypotonic second solution is generated by an automated apparatus according to a predetermined program.

46. The process according to claim 44, wherein the concentration of the glucose in the isotonic or hypotonic second solution is about 0.5 g/dL to about 2.5 g/dL.
